(19) United States
(12) Patent Application Publication
(10) Pub. No.: US 2018/0195836 A1
(43) Pub. Date: Jul. 12, 2018

(54) LASER SIGHT DEVICE WITH VARIABLE POWER OUTPUT

(71) Applicant: SureFire, LLC, Fountain Valley, CA (US)

(72) Inventors: John W. Matthews, Newport Beach, CA (US); William A. Hunt, Foothill Ranch, CA (US)

(21) Appl. No.: 15/867,604

(22) Filed: Jan. 10, 2018

Related U.S. Application Data
(60) Provisional application No. 62/444,743, filed on Jan. 10, 2017.

(51) Int. Cl. F41G 1/35; F41G 1/473; F41C 27/00; F41G 1/36; F41H 13/00; G01B 11/14

(52) U.S. Cl. CPC F41G 1/35; F41G 1/473; F41C 27/00; F41A 19/11; F41H 13/005; G01B 11/14; F41G 1/36

(57) ABSTRACT

A laser sight device for a firearm is provided with a variable power output. In one example, the laser sight device may include a laser assembly configured to provide a laser beam. The laser sight device may include a sensor configured to provide a sensor signal comprising a motion parameter value associated with motion of the laser sight device detected by the sensor while the laser sight device is attached to the firearm. The laser sight device may include a controller configured to provide a control signal to the laser assembly to selectively adjust an intensity of the laser beam in response to the motion parameter value. Additional features and related methods are also provided.

### CROSS-REFERENCE TO RELATED APPLICATIONS

This application claims priority to and the benefit of U.S. Provisional Patent Application No. 62/444,743 filed Jan. 10, 2017 and entitled “LASER SIGHT DEVICE WITH VARIABLE POWER OUTPUT” which is hereby incorporated by reference in its entirety.

### TECHNICAL FIELD

The invention relates to sights for firearms and, more specifically, to laser sight devices having variable power output.

### BACKGROUND

Laser sight devices are frequently employed on firearms to acquire and/or intimidate potential targets. Conventional laser sight devices generally provide a laser beam having a fixed beam intensity. For such devices, the laser beam may be highly visible when the laser beam is at rest on a potential target.

Unfortunately, such conventional laser sight devices are generally not well suited for use while a firearm is in motion. In this regard, the lasers employed by such devices are often limited in power output. As a result, the emitted laser beam may not always be visible to the user as the firearm is rapidly swept across a scene.

This is particularly true in high-stress scenarios where an assailant may be quickly approaching a user. In such cases, the user must be able to immediately locate the moving laser beam of the laser sight device to determine if the firearm is aligning with the assailant. If the laser is not sufficiently visible and becomes lost in the details of the scene, the user may be unable to use the laser sight device effectively. Indeed, failure to see the laser could result in harm or death of the user or a bystander. A need therefore exists for improved laser sight devices and associated methods of operation.

### SUMMARY

In accordance with various embodiments further discussed herein, a laser sight device with a variable power output and methods of operation of the laser sight device are provided to generate a laser beam that may be automatically adjusted in intensity in response to motion detected by a sensor of the laser sight device. In various embodiments, the laser sight device may provide a laser beam and may be mounted to a firearm, such as a handgun, to provide a firearm assembly. In response to a movement of the firearm assembly that sweeps the laser beam across a scene, the laser may vary the output power and thus the output intensity of the beam may be adjusted accordingly.

In one embodiment, a laser sight device for a firearm may include: a laser assembly configured to provide a laser beam; a sensor configured to provide a sensor signal comprising a motion parameter value associated with motion of the laser sight device detected by the sensor while the laser sight device is attached to the firearm; and a controller configured to provide a control signal to the laser assembly to selectively adjust an intensity of the laser beam in response to the motion parameter value.

In another embodiment, a method may include: attaching a laser sight device to a firearm, wherein the laser sight device comprises a laser assembly configured to provide a laser beam; detecting, by a sensor of the laser sight device, motion of the laser sight device; providing, by the sensor, a sensor signal comprising a motion parameter value in response to the detected motion; providing, by a controller of the laser sight device, a control signal to the laser assembly in response to the motion parameter value; and selectively adjusting, by the control signal, an intensity of the laser beam.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a perspective view of a firearm assembly in accordance with an embodiment of the disclosure.

FIG. 2 illustrates a block diagram of a laser sight device in accordance with an embodiment of the disclosure.

FIG. 3 illustrates a perspective view of a laser beam of the firearm assembly being swept across a scene in accordance with an embodiment of the disclosure.

FIG. 4 illustrates a top-bottom view of the laser beam of the firearm assembly being swept across the scene in accordance with an embodiment of the disclosure.

FIG. 5 illustrates a graph showing variations in intensity of the laser beam of the laser sight device in accordance with an embodiment of the disclosure.

FIG. 6 illustrates a method of operating the laser sight device in accordance with an embodiment of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

In accordance with various embodiments provided herein, a laser sight device may be implemented with a laser having a variable power output. In this regard, the laser may generate a laser beam that may be automatically adjusted in intensity in response to one or more detected motion parameters of the laser sight device. Such a laser sight device may be used in any desired combination with various features identified in the present disclosure. In certain embodiments, the laser sight device may be particularly suited for use in tactical and combat environments requiring, for example, sighting assistance. More specifically, the laser sight device may detect a motion parameter (e.g., acceleration, velocity, and/or orientation) and adjust the power output of a laser of the laser sight device in response to motion parameter values provided by sensors of the laser sight device such that a user may easily see the laser beam, for example, when the beam is swept across a scene.

In accordance with various embodiments, the laser sight device may provide a laser beam (also referred to herein as a “beam”) and may be mounted to a weapon (e.g., a firearm, such as a pistol) to provide a firearm assembly. In response to a movement (e.g., linear or angular displacement) of the firearm assembly, the output of the beam, e.g., power, luminosity, optical intensity, and/or brightness (e.g., radiance), is adjusted.

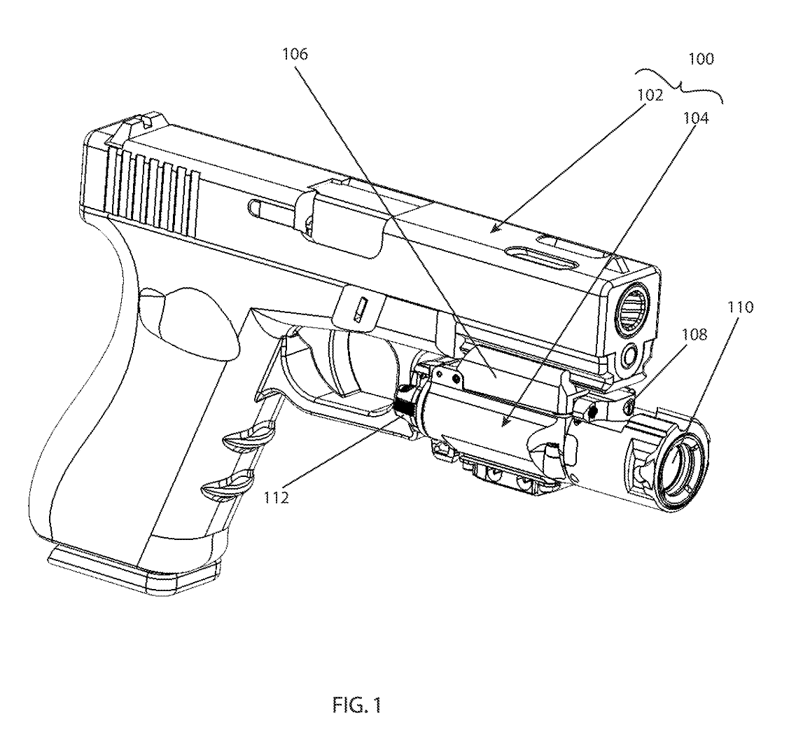

Referring now to the drawings, wherein the showings are for purposes of illustrating embodiments of the present invention only and not for purposes of limiting the same, FIG. 1 illustrates a perspective view of a firearm assembly 100 including a firearm 102 and a laser sight device 104 in accordance with an embodiment of the disclosure.

Laser sight device 104 may be mounted to, for example, a rail (e.g., Picatinny or universal rail) of firearm 102 using, for example, an attachment mechanism 106. In one or more embodiments, laser sight device 104 includes a laser 108 and user controls 112. In an embodiment, laser sight device 104 may include a light source 110 used to illuminate a desired scene. User controls 112 may be used to activate laser 108 and/or light source 110 and transmit a user control signal to controller 204. In another embodiment, user controls 112 may provide momentary buttons. Though shown as buttons in the figures, user controls 112 may also be switches, rockers, sliders, or other control mechanisms.

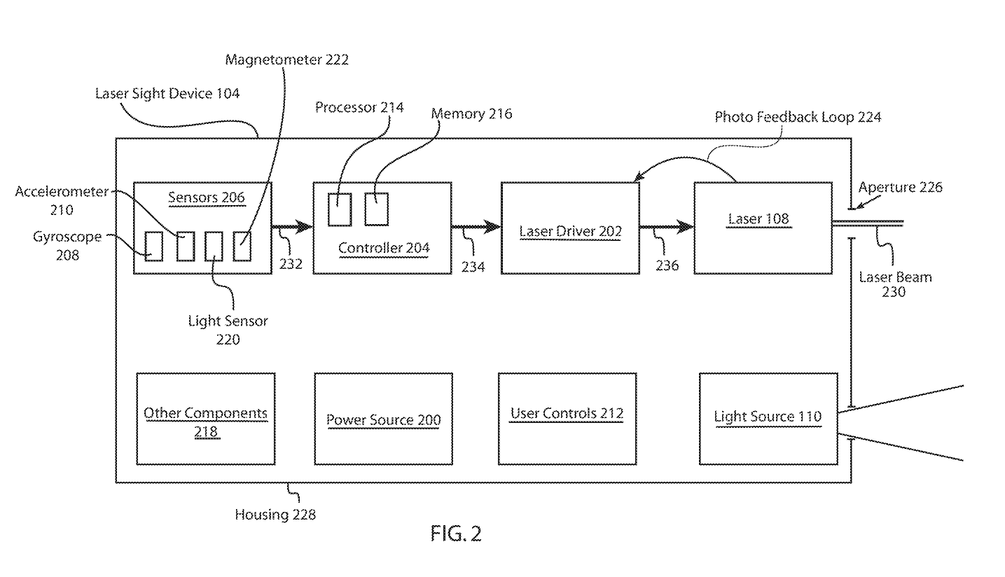

FIG. 2 illustrates a block diagram of laser sight device 104. Laser sight device 104 may include a housing 228 at least partially enclosing sensors 206, a controller 204, a laser assembly providing a laser driver 202 and a laser 108 providing a laser beam 230, a power source 200 (e.g., batteries, such as lithium ion, lithium manganese CR123A, or other battery), user controls 212, a light source 110 that may provide a light beam, and other components 218.

Sensors 206 may, for example, include an accelerometer 210, a gyroscope 208 (e.g., 3-axis gyroscope), a light sensor 220, and a magnetometer 222. Though not shown, sensors 206 may include various other types of sensors, such as a proximity sensor, an inclinometer, and/or other sensors. Sensors 206 may be independently manufactured sensors or provided in a set package provided by a manufacturer. In one or more embodiments, sensors 206 may detect a motion of laser sight 104 (e.g., a motion of laser sight device 104 while attached to firearm 102, thus a motion of firearm assembly 100). In response to the detected motion, sensors 206 may provide a sensor signal 232 including a motion parameter value associated with the movement and motion parameter of laser sight device 104. Sensor signal 232 may be a continuous analog signal with a continuously varying voltage of the signal or a digital signal that is an electrical signal with discrete values. The motion parameter value may be a voltage, current, and/or data value provided by sensor signal 232. In an embodiment, sensors 206 may include a microprocessor that processes the motion parameter values and then provides the processed values (e.g., velocity value determined from, for example, acceleration and/or gyroscope values) in sensor signal 232 to controller 204. In another embodiment, sensors 206 may provide sensor signal 232, which includes the detected motion parameter value to controller 204.

For example, accelerometer 210 may detect the acceleration (e.g., a motion parameter) of laser sight device 104 and provide the value to controller 204 in sensor signal 232. Gyroscope 208 may also detect a tilt (e.g., a motion parameter) of laser sight device 104 and magnetometer 222 may detect an orientation (e.g., a motion parameter) of laser sight device 104 and provide the values of the motion parameters to controller 204 using sensor signal 232. Processor 214 of controller 204 may use one or more of the provided motion parameter values to, for example, integrate the acceleration and determine one or more other motion parameter value (e.g., velocity value). For example, in an embodiment, magnetometer 222 or gyroscope 208 may provide magnetic field data or orientation data, respectively, to be combined with acceleration data acquired from accelerometer 210 (with the acceleration of gravity filtered out) to provide a tilt and velocity of laser sight device 104. Controller 204 may then provide a control signal 234 to the laser assembly to selectively adjust an intensity of laser beam 230 in response to the motion parameter values, as discussed further herein.

Controller 204 may include processor 214 and a memory 216. Processor 214 may be implemented, for example, as a microcontroller, microprocessor, a Field Programmable Gate Array (FPGA), an Application Specific Integrated Circuit (ASIC), and/or any appropriate combination of these or other types of devices.

Memory 216 (e.g., implemented as any appropriate type of volatile and/or non-volatile memory) may be used to store instructions and/or data. For example, in some embodiments, memory 216 may be implemented as a non-transitory machine-readable medium storing various instructions which may be executed by processor 214 to perform various operations such as receiving and processing operating instructions or sensor signal 232. In some embodiments, such a machine-readable medium may be provided within processor 214 itself (e.g., as firmware and/or otherwise) and/or external to processor 214. Processor 214 may include processing circuitry disposed within housing 228 of laser sight device 104 and may be configured to receive sensor signal 232 from sensors 206. Controller 204 may provide control signal 234 in response to the processed motion parameter values to laser driver 202, which may provide a laser driver signal 236 to laser 108, as discussed further herein. Various other components of laser sight device 104, such as light source 110, may receive control signal 234 from controller 204.

In an embodiment, laser sight device 104 may include light source 110. Light source 110 may be, for example, a light emitting diode (LED), an incandescent light bulb, a tungsten-halogen light bulb, a fluorescent light bulb, a high-intensity discharge light bulb, or any other singular or plural light source devices. Laser sight device 104 may include one light source, two light sources, or more than two light sources. In an embodiment, light source 110 may generate light of various wavelengths (e.g., different colors of visible light such as red light, blue light, violent light, green light, or combinations thereof and/or invisible light, such as infrared light or ultraviolet).

In one or more embodiments, laser 108 may generate laser beam 230, which travels through an aperture 226 of housing 228. Laser 108 may be mounted to a heat sink on housing 228, allowing laser 108 to operate at a maximum power output. In an embodiment, laser 108 may be a solid-state laser. In other embodiments, laser 108 may be a gas laser, chemical, laser, semiconductor laser, metal vapor laser, or other type of laser. The laser radiation may be various values, for example, laser beam 230 may have a visible wavelength within the range 400 nm and 700 nm (nanometers) or laser beam 230 may be an infrared or ultraviolet beam used with night vision accessories. For example, laser beam 230 may be a green laser with a wavelength of approximately 530 nm. The power output (milliwatts, or mW) of laser 108 may be varied in response to laser driver signal 236 (e.g., a current signal) from laser driver 202, which in turn provided laser driver signal 236 to laser 108 in response to controller signal 234. Laser 108 may generate laser beams of different powers. For example the output power of laser 108 may range from 5 mW to 50 mW. In another embodiment, the minimum power may be more or less than 5 mW and the maximum power may be more or less than 50 mW. In an embodiment, laser driver 202 may provide a current at an appropriate level to laser 108 (e.g., laser diodes) to determine the output power of laser 108. Laser 108 may provide a photo feedback loop 224 (e.g., the laser driver may allow control based on, for example, the laser diode or a photodiode current) to laser driver 202 for adjustment of laser driver signal 236 to laser 108.

In an embodiment of the disclosure, a motion-controlled laser or light source may be provided in which accelerometer 210 or other motion detection circuitry (e.g., gyroscope 208), may provide information about the motion of laser sight device 104 or firearm assembly 100, e.g., detect motion parameters (e.g., the orientation, rate, direction, or pattern of movement). The motion parameter values may be provided to processor 214 of laser sight device 104. In response to the detected motion parameter values, laser 108 or light source 110 may react (e.g., turn on, turn off, flash, strobe, or increase or decrease in intensity or brightness) based on the motion parameter values.

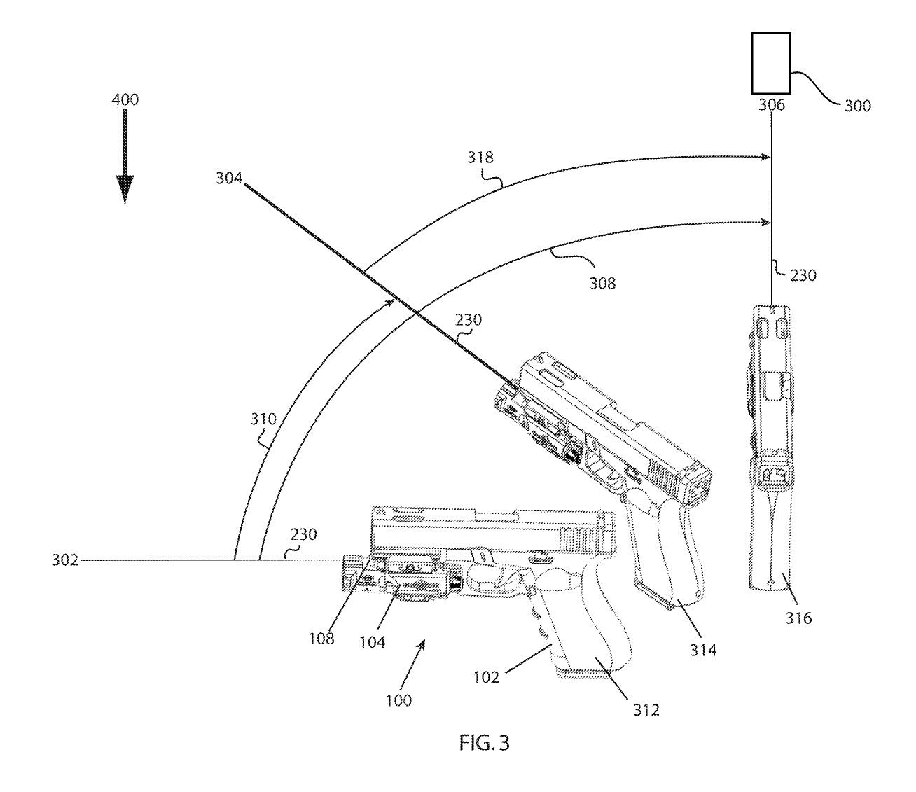

FIG. 3 illustrates a perspective view of beam 230 of firearm assembly 100 being swept across a scene in accordance with an embodiment of the disclosure. In one or more embodiments of the disclosure, Firearm assembly 100 may be at rest in a position 312. Laser sight device 104 may provide laser beam 230 at a minimum output (e.g., 5-mW output power of beam 230 such that beam 230 is at a minimum intensity) directed at a location 302 of a scene in an environment. For example, a user may draw firearm assembly 100 from a holster and aim firearm 102 and laser sight device 104 at a location 302. Sensors 206 detect a motion parameter value that does not exceed a minimum threshold therefore a minimum-intensity beam 230 is emitted from laser 108. Therefore, laser sight device 104 provides beam 230 at a minimum intensity that appears on location 302, notifying the user of the general point of aim of firearm 102.

Firearm assembly 100 may be moved by the user from position 312 to an intermediate position 314 (e.g., firearm assembly 100 is moving and laser beam 230 passes over location 304 of the scene). For example, the user may move firearm assembly 100 from position 312 to intermediate position 314 (as indicated by directional arrow 310) when attempting to align laser sight device 104 and corresponding beam 230 with target 300 at location 306 (indicated by directional arrow 308). Sensors 206 may detect the movement (e.g., motion parameter) of firearm assembly 100. The motion parameter value may be provided by sensors 206 to controller 204 using sensor signal 232 which is then processed by processor 214, as discussed herein.

In one or more embodiments of the disclosure, if the motion parameter value does not exceed a predetermined minimum threshold (e.g., the firearm assembly is moving below a predetermined velocity value), beam 230 will remain at a minimum intensity output (or, for example, a 5-mW power output). However, if the motion parameter value detected by sensors 206 is determined by controller 204 to exceed the minimum threshold, then the output of laser 108 is adjusted (e.g., gradual or relatively incremental increase in laser power relative to the determined velocity value). In an embodiment, controller 204 may relatively frequently receive sensor signals 232 with new motion parameter values from sensors 206 and process the new motion parameter values to determine if the new motion parameter values of firearm assembly 100 continue to exceed the minimum threshold, exceed the maximum threshold, or if beam 230 should be adjusted to various intermediate output intensities correlating to the new motion parameter values.

In one or more embodiments, the motion parameter value may exceed a predetermined maximum threshold. For example, the motion parameter value of firearm assembly 100 at position 304 may exceed the maximum threshold and laser beam 230 may be adjusted to a maximum power output (e.g., 50 mW).

For example, a user may move firearm assembly 100 from position 312 to intermediate position 314, sweeping laser beam 230 across the scene from location 302 to intermediate location 304. At intermediate location 304, the motion parameter value may exceed the maximum threshold. In response to the detected motion parameter, sensor 206 may provide sensor signal 232 with motion parameter value to controller 204, which processes the value using processor 214 and may provide control signal 234 to the laser assembly which, in response, emits beam 230 at the maximum intensity. If the subsequent detected motion parameter values remain above the maximum threshold, then the maximum-intensity beam output may be maintained.

The adjusted (e.g., increased) intensity of beam 230 allows the user to easily locate an intermediate location which beam 230 is temporarily located at (e.g., a location between locations 302 and 306, such as location 304), allowing the user to easily track beam 230 and thus the point of aim of firearm 102. For example, in an environment with substantial lighting, a low laser output may not be seen by the user, especially when rapidly displaced across a scene. Thus, a motion parameter value may be detected by sensors 206 and determined by controller 204. Controller 204 may provide control signal 234 to the laser assembly and the intensity of laser beam 230 may be adjusted to an intermediate or maximum intensity relative to whether the motion parameter value exceeds the minimum or maximum threshold, respectively.

In one or more embodiments, firearm assembly 100 may move from intermediate position 314 to position 316. Beam 230 may thus traverse, or sweep, across the scene from intermediate location 304 to target location 306 (as indicated by directional arrow 318). Beam 230 may adjust (e.g., decrease) in intensity in response to the detected and/or processed motion parameter value. In one or more embodiments, the intensity output of beam 230 may correlate with a specific motion parameter value, or a specific range of motion parameter values, and adjust according to the value detected.

In an embodiment, a change in the motion parameter value may be detected by sensors 206 and sensor signal 232 may be generated and provided to controller 204 in response (e.g., firearm assembly 100 may decrease in velocity from intermediate position 314 to position 316 and a corresponding velocity value may be provided in sensor signal 232 to controller 204). The output power of laser 108 may adjust relative to the detected motion parameter value (e.g., laser beam 230 may decrease in intensity in response to the decrease in the motion parameter value).

In an embodiment, the output of laser 108 may relatively rapidly increase or decrease and “jump” from a minimum intensity beam to a maximum intensity beam or vice versa, respectively, without providing intermediate intensities. In another embodiment, the intensity and brightness of beam 230 may adjust gradually, relative to the motion parameter of firearm assembly 100. For example, a user may slow the velocity of firearm assembly 100 from position 314 to position 316 along directional arrow 318. In response, the beam 230 may gradually decrease to various intermediate intensities. The user may stop firearm assembly 100 in position 316 and beam 230 may be on target 300 at location 306. The motion parameter value may no longer exceed the minimum threshold and the beam intensity is adjusted to the minimum intensity. Due to the user having tracked the point of laser beam 230 from location 302 to location 306, the user may relatively easily spot laser 230 on target 300 at the minimum intensity.

In an embodiment, the motion parameter may be an acceleration of firearm assembly 100 detected by accelerometer 210. In an embodiment, the motion parameter may be an orientation of firearm assembly 100. For example, laser sight device 104 may turn on or increase laser 108 output (as discussed herein) in response to a variation in orientation, such as from a vertical orientation to a horizontal orientation when firearm assembly 100 is pulled from a holster.

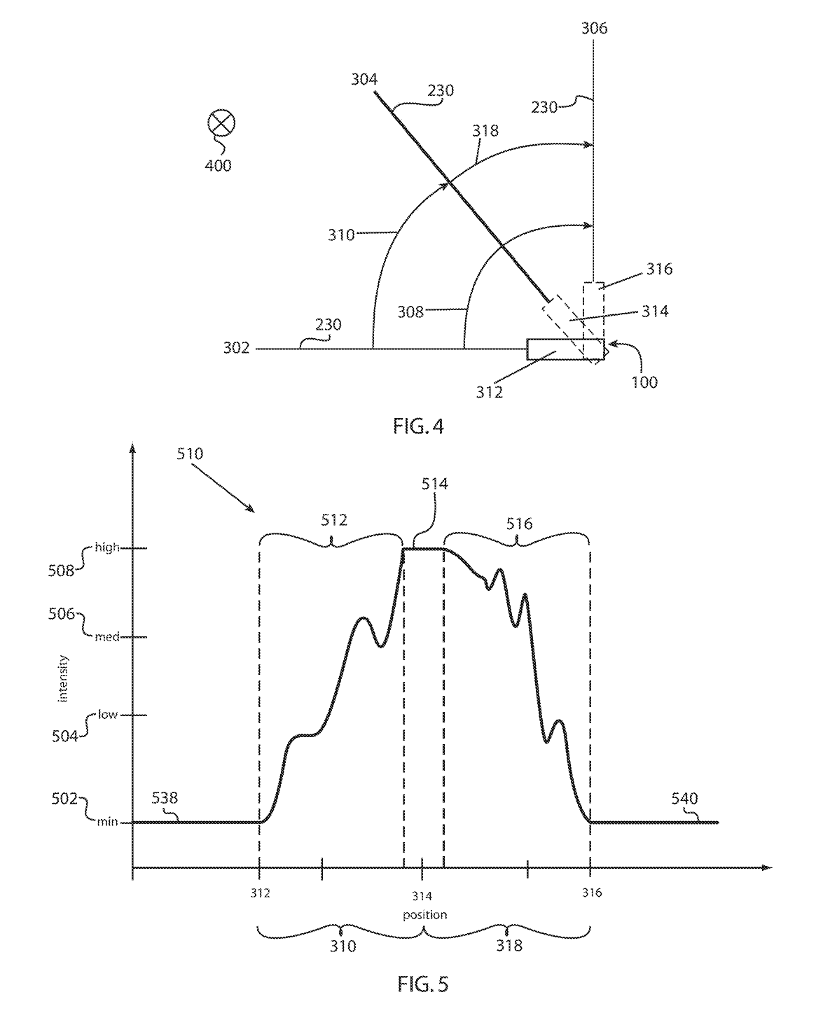

FIG. 4 illustrates a top-bottom view of beam 230 of firearm assembly 100 being swept across the scene (as shown along line 400 of FIG. 3) in accordance with an embodiment of the disclosure. In an embodiment of the disclosure, a user may be in a situation that requires the user to draw firearm assembly 100. The user may activate laser sight device 104 such that laser 108 emits a beam 230 at a low power and minimum intensity on to a location 302 of a scene. The user may identify target 300 at location 306 and sweep beam 230 across the scene (as indicated by directional arrow 308) to direct a point of aim of firearm assembly 100 on to target 300. As moving firearm assembly 100, the user may sweep beam 230 across a location 304.

For example, the motion parameter value (e.g., velocity value) of firearm assembly 100 may exceed a maximum threshold, thus resulting in laser beam 230 adjusting (e.g., increasing) to a maximum intensity for greater visibility. The motion of firearm assembly 100 results in a rapid movement of laser beam 230 over intermediate locations of the scene, such as intermediate location 304, such that the maximum intensity beam resides on intermediate locations for a relatively short duration of time. Beam 230 may maintain the maximum intensity as firearm assembly 100 is continued to be moved by the user, thus allowing the user to easily locate moving beam 230 (e.g., the point of laser beam 230). The user may then slow firearm assembly 100 such that beam 230 comes to rest on target 300 at location 306. Beam 230 may gradually adjust (e.g., decrease) to the minimum intensity in response to the motion parameter value (e.g., velocity value) detected by sensors 206. Beam 230 may maintain the minimum intensity while the point of aim of firearm assembly 100 is directed and relatively rested on target 300 at location 306 such that the motion parameter value does not exceed the minimum threshold.

FIG. 5 illustrates a graph showing variations in intensity of laser beam 230 of laser sight device 104 that correlates with the exemplary movement described in FIGS. 4 and 5 in accordance with an embodiment of the disclosure. A y-axis of the graph represents the intensity of laser beam 230 and an x-axis of the graph represents the position of firearm assembly 100. Though the output of laser beam 230 has been described in regards to having a minimum power output of 5 mW and a maximum power output of 50 mW, the laser beam may be adjusted to provide other beam ranges with various other minimum and maximum outputs in any combination.

In an embodiment of the disclosure, plot 510 represents beam 230 at continuously varying intensities relative to detected movement of firearm assembly 100. The intensity of beam 230 is shown in response to motion parameters detected at various positions, such as positions 312, 314, and 316 of firearm assembly 100.

Plot 510 has a baseline portion 538 as firearm assembly 100 is in position 312 and beam 230 is directed at location 302. Firearm assembly 100 is at rest in position 312, thus the motion parameter value does not exceed the minimum threshold (e.g., the determined velocity is approximately zero) and, in response, laser sight device 104 emits beam 230 at a minimum intensity 502 (e.g., laser 108 operates at a 5-mW output).

Firearm assembly 100 may move (e.g., providing a motion parameter, such as acceleration) from position 312. As described herein, the intensity of beam 230 may adjust in response to the corresponding motion parameter value, as shown by portion 512 of plot 510. For example, the intensity of beam 230 may adjust from a minimum intensity 502 to approximately a low intensity 504 and then approximately a medium intensity 506, in correlation with the intermediate movements of firearm assembly 100.

In one or more embodiments, the intensity of beam 230 may continuously vary relative to subsequent motion parameters (e.g., angular velocity values continuously detected over time). For example, each motion instance may provide a motion parameter value that is detected by sensors 206 and, in response, the intensity may variably alter relative to the detected motion parameter values (e.g., the power and intensity of the laser may vary relative to the motion parameter values detected every, for example, millisecond). Thus, the intensity may continuously fluctuate (e.g., increase or decrease) in response to the varying motion parameter (e.g., angular velocity) of firearm assembly 100.

In an embodiment, firearm assembly 100 may exceed a maximum threshold and laser beam 230 may adjust to a high intensity 508 (e.g., maximum intensity), such as when firearm assembly 100 moves to intermediate position 314 and beam 230 is on location 304 as discussed herein. If the subsequent motion parameter values of firearm assembly 100 continue to exceed the maximum threshold, laser beam 230 will maintain high intensity 508 as shown by portion 514 of plot 510.

From intermediate position 314 to position 316, the motion parameter value may change (e.g., acceleration value detected by sensors 206) as firearm assembly 100 moves from intermediate position 314 to position 316 such that beam 230 stops on location 306 (e.g., on target 300). For example, beam 230 may maintain high intensity 508 until the motion parameter value no longer exceeds the maximum threshold, which would result in the power of beam 230 adjusting relative to the moving (e.g., decelerating) firearm assembly 100 as it approaches location 306, as described previously herein. Beam 230 may overall decrease from high intensity 508 to medium intensity 506 to low intensity 504 (as shown by portion 516 of plot 510). Once the motion parameter value no longer exceeds the minimum threshold and, for example, firearm assembly 100 comes to rest in position 316, beam 230 may adjust to minimum intensity 502, as shown in baseline portion 540.

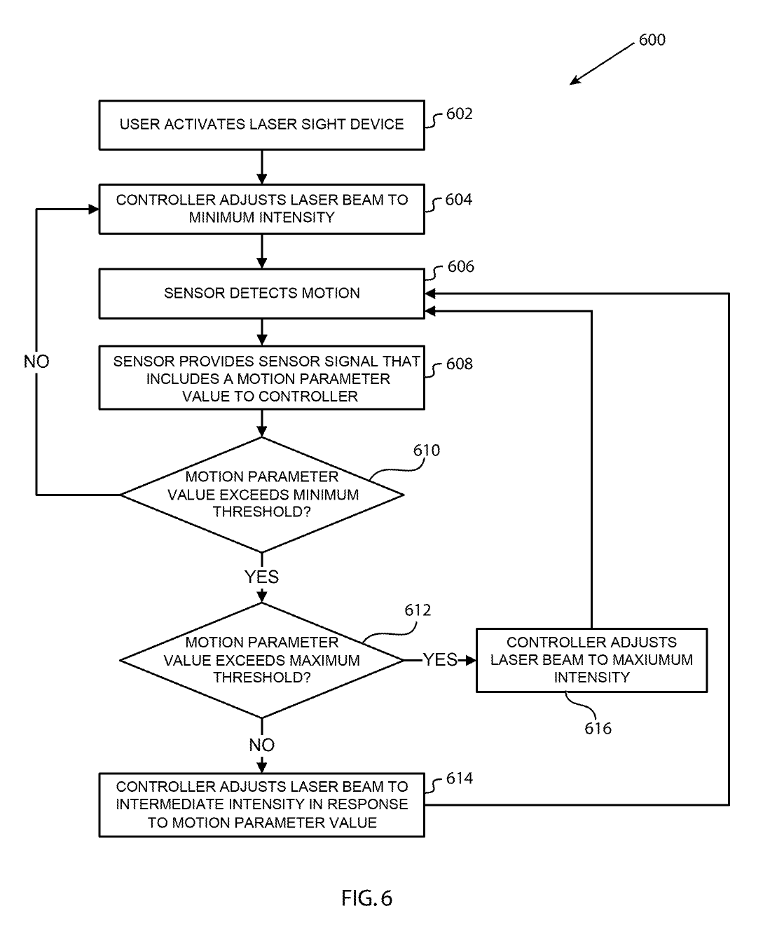

FIG. 6 illustrates a method 600 of operation for laser sight device 104 in accordance with an embodiment of the disclosure. In block 602, a user attaches laser sight device 104 to firearm 102 and activates laser sight device 104. Laser 108 of laser sight device 104 may operate at the minimum power (e.g., 5 mW), and provide minimum intensity beam 230, upon activation in response to control signals 234 from controller 204 as described herein (block 604).

In block 606, sensors 206 may detect motion of laser sight device 104. The motion parameter value may be detected by sensors 206 (e.g., accelerometer and gyroscope) and sensor signal 232 may provide the motion parameter value to controller 204 (block 608) in response to the detection. Controller 204 may determine a motion parameter value from the values provided by sensors 206 and/or may use the values provided directly. Controller 204 may then determine if the motion parameter value exceeds a minimum threshold (block 610). In block 604, if the motion parameter value does not exceed the minimum threshold, the laser beam remains at a minimum power, e.g., minimum intensity (e.g., portion 538 of FIG. 5). For example, referring back to FIGS. 3 and 4, laser sight device 104 is activated, but firearm assembly 100 is at rest in position 312 with laser 108 directed at location 302. The motion parameter value, therefore, does not exceed the minimum threshold and thus beam 230 remains at the minimum intensity and displays a low radiance beam, or point, on location 302.

In block 612, if the motion parameter value exceeds the minimum threshold, controller 204 may then determine if the motion parameter value exceeds the maximum threshold. If the motion parameter value does not exceed the maximum threshold controller 204 adjusts laser beam 230 to an intermediate intensity (e.g., portion 512 of FIG. 5) in response to the motion parameter value (block 614). Once beam 230 has been adjusted sensors 206 further detect motion to determine if the output of laser 108 should be further adjusted. For example, controller 204 may adjust control signal 234 in response to sensor signal 2′32 to increase the intensity of beam 230 from a minimum intensity to an intermediate intensity in response to a first motion parameter value. Subsequently, a second motion parameter value greater than the first motion parameter value may be detected by sensors 206 (block 606) and provide to controller 204 in sensor signal 232 (block 608). Controller 204 may increase the intensity of beam 230 from the intermediate intensity to a second intermediate intensity in response to the second motion parameter (block 614).

In block 616, if the motion parameter value does exceed the maximum parameter, controller 204 may adjust laser beam 230 to a maximum intensity (e.g., portion 514 of FIG. 5). For example, controller 204 may adjust control signal 234 in response to sensor signal 232 to increase the intensity of beam 230 from a minimum intensity to an intermediate intensity in response to a first motion parameter value (e.g., firearm assembly 100 moving from position 312 to intermediate position 314, resulting in an increase in velocity and thus an increase in the intermediate intensities of beam 230). Subsequently, a second motion parameter value greater than the first motion parameter value may be detected by sensors 206 (block 606) and provide to controller 204 in sensor signal 232 (block 608). Controller 204 may increase the intensity of beam 230 from the intermediate intensity to a maximum intensity in response to the second motion parameter (block 616).

Controller 204 may provide a control signal 234 to the laser assembly, for example, laser driver 202 may receive control signal 234 and, in response, provide a laser driver signal 236 to laser 108 (e.g., laser diodes). Laser 108 may then generate beam 230 at the maximum intensity. Once beam 230 has been adjusted sensors 206 may detect further motion (block 606) and provide the sensor signal 232 to controller 204 (block 608) to determine if the output of laser 108 should be further adjusted. For example, if a subsequent motion parameter value falls below the maximum threshold, the intensity of beam 230 may adjust to intermediate intensities (e.g., portion 516 of FIG. 5). If the motion parameter value no longer exceeds the minimum threshold, beam 230 may be adjusted to the minimum intensity (e.g., portion 540 of FIG. 5).

For example, referring back to FIGS. 3 and 4, firearm assembly 100 may decrease in velocity from intermediate position 314 to position 316. The change in the motion parameter and thus the motion parameter value may be detected by sensors 206. Sensor signal 232 may then be generated and provided to controller 204 which provides control signal 234 to the laser assembly. As a result, the intensity of beam 230 may be adjusted by the laser assembly relative to the detected motion parameter value (e.g., laser beam 230 may decrease to an intermediate intensity or to the minimum intensity).

The disclosure is not intended to limit the present invention to the precise forms or particular fields of use disclosed. It is contemplated that various alternate embodiments and/or modifications to the present invention, whether explicitly described or implied herein, are possible in the rail clamp of the disclosure. For example, it is contemplated that the various embodiments set forth herein may be combined together and/or separated into additional embodiments where appropriate.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A laser sight device for a firearm, the laser sight device comprising:
a laser assembly configured to provide a laser beam;
a sensor configured to provide a sensor signal comprising a motion parameter value associated with motion of the laser sight device detected by the sensor while the laser sight device is attached to the firearm; and
a controller configured to provide a control signal to the laser assembly to selectively adjust an intensity of the laser beam in response to the motion parameter value.

2. The laser sight device of claim 1, wherein the controller is configured to adjust the control signal to increase the intensity of the laser beam while the motion parameter value is greater than a threshold value.

3. The laser sight device of claim 1, wherein the controller is configured to maintain the control signal to maintain the intensity of the laser beam at a minimum intensity while the motion parameter value is less than a threshold value.

4. The laser sight device of claim 3, wherein the minimum intensity corresponds to a power output of 5 mW.

5. The laser sight device of claim 1, wherein the controller is configured to adjust the control signal to increase the intensity of the laser beam from a minimum intensity to a maximum intensity while the motion parameter value is greater than a threshold value.

6. The laser sight device of claim 1, wherein the controller is configured to adjust the control signal to adjust the intensity of the laser beam over a range from a minimum intensity to a maximum intensity in response to a corresponding range of motion parameter values.

7. The laser sight device of claim 1, wherein the controller is configured to adjust the control signal to:
increase the intensity of the laser beam from a minimum intensity to an intermediate intensity in response to a first motion parameter value; and
increase the intensity of the laser beam from the intermediate intensity to a maximum intensity in response to a second motion parameter value greater than the first motion parameter value.

8. The laser sight device of claim 1, wherein the motion parameter value is a voltage, current, and/or data value provided by the sensor signal.

9. The laser sight device of claim 1, wherein the sensor is an accelerometer and/or a gyroscope, and the motion parameter value is an acceleration value and/or a velocity value.

10. The laser sight device of claim 1, wherein the laser assembly comprises:
a laser driver configured to receive the control signal; and
a laser configured to generate the laser beam in response to the laser driver.

11. A method comprising:
attaching a laser sight device to a firearm, wherein the laser sight device comprises a laser assembly configured to provide a laser beam;
detecting, by a sensor of the laser sight device, motion of the laser sight device;
providing, by the sensor, a sensor signal comprising a motion parameter value in response to the detected motion;
providing, by a controller of the laser sight device, a control signal to the laser assembly in response to the motion parameter value; and
selectively adjusting, by the control signal, an intensity of the laser beam.

12. The method of claim 11, wherein the selectively adjusting comprises increasing the intensity of the laser beam while the motion parameter value is greater than a threshold value.

13. The method of claim 11, wherein the selectively adjusting comprises maintaining the intensity of the laser beam at a minimum intensity while the motion parameter value is less than a threshold value.

14. The method of claim 13, wherein the minimum intensity corresponds to a power output of 5 mW.

15. The method of claim 11, wherein the selectively adjusting comprises increasing the intensity of the laser beam from a minimum intensity to a maximum intensity while the motion parameter value is greater than a threshold value.

16. The method of claim 11, wherein the selectively adjusting comprises adjusting the intensity of the laser beam over a range from a minimum intensity to a maximum intensity in response to a corresponding range of motion parameter values.

17. The method of claim 11, wherein the selectively adjusting comprises:
increasing the intensity of the laser beam from a minimum intensity to an intermediate intensity in response to a first motion parameter value; and
increasing the intensity of the laser beam from the intermediate intensity to a maximum intensity in response to a second motion parameter value greater than the first motion parameter value.

18. The method of claim 11, wherein the motion parameter value is a voltage, current, and/or data value provided by the sensor signal.

19. The method of claim 11, wherein the sensor is an accelerometer and/or a gyroscope, and the motion parameter value is an acceleration value and/or a velocity value.

20. The method of claim 11, wherein the laser assembly comprises:
a laser driver configured to receive the control signal; and
a laser configured to generate the laser beam in response to the laser driver.
